(19) United States
(12) Patent Application Publication
(10) Pub. No.: US 2005/0144016 A1
(43) Pub. Date: Jun. 30, 2005

(54) Method, software and apparatus for creating audio compositions

(76) Inventors: Christopher Hewitt, Aurora, CO (US); Kenneth Miller, Roseville, CA (US)

Correspondence Address: Christopher Hewitt, 4145 South Lewiston Circle, Aurora, CO, 80013, US

(21) Appl. No.: 11/001,307

(22) Filed: Dec. 2, 2004

Related U.S. Application Data
(60) Provisional application No. 60/528,921, filed on Dec. 11, 2003.
(60) Provisional application No. 60/526,921, filed on Dec. 3, 2003.

(51) Int. Cl. G10L 13/00

(52) U.S. Cl. 704/278

(57) ABSTRACT

Herein described are various systems for the creation of unique audio compositions by first searching collections of purpose-created audio layers and then selecting audio layers that meet the user's criteria. The unique structure and classification of audio layers in the library allows non-musicians a foolproof method to compose harmonious and synchronous original compositions. The user previews versions of the selected layers and mixes the layers to obtain a draft multilayer version of the desired sounds. Once a desired sound is achieved, the user can then download high resolution performance versions the compiled layers or individual selected audio layers to mix and achieve the desired final audio composition.

### RELATED APPLICATIONS

This application claims priority to provisional application No. 60/526,921, filed Dec. 3, 2003, which is incorporated herein by reference in it's entirety.

### BACKGROUND OF THE INVENTION

A. Field of the Invention

The present invention relates to a web-browser based, computer-implemented method to create completely synchronous and harmonious custom audio compositions meeting the user's style and meter requirements by the systematic assembly of individual sounds, selected from a library of purpose-created audio, into custom audio compositions. The invention also relates to the unique structure and properties of the individual audio library sounds that facilitate the assembly, and to the unique organization of the audio library that facilitates the selection of appropriate individual sounds. The invention also relates to a unique business method employed by enabling computer technology software. The invention further relates to a computer service available over a communications link, such as a local area network, Intranet or the Internet that allows a user or users to create custom musical compositions by assembling purpose-composed sound sources available from a either local or remote audio library.

B. Background

In recent years, the creation of music has evolved into a small industry including both amateurs and professionals.

Many amateur musicians use devices such as CD players, DVD players and pre-programmed keyboards that have existing songs and/or rhythm tracks that allow them to play along or sing along with the music in such settings as, for instance, a karaoke bar. Such devices are limited in versatility and are generally not used for the creation of new sounds or by the professional composer.

Professional composers use relatively sophisticated tools incorporating MIDI (Musical Instrument Digital Interface) and similar systems that allow them to make generic digital recordings that can be designated as certain sounds. These recordings are, generally speaking fixed performances. The performances, if flawed, must either be recreated, or digitally altered to bring the work quality to a desired level of professional composition. Performance and subsequent digital editing requires considerable time and effort.

In many professional applications, there are instances when even powerful digital tools such as MIDI devices and digital recordings cannot provide a composer with the tools necessary to rapidly create audio compositions to suit a specific purpose. There is a genuine need for a means for more rapidly creating audio compositions without the tedious and demanding process of iterative recording and subsequent digital refinement to achieve acceptable quality.

To a very great extent, the contemporary composer relies on readily-available and mature devices and technologies that produce continuous audio tracks by simply repeating a short sound an indefinite number of times forming a “loop”. The present invention does not require looping techniques.

To a very great extent, the contemporary composer relies on readily-available and mature devices and technologies that digitally modify the length of audio tracks to using temporal compression and extension algorithms. The present invention does not require time compression or extension techniques to change the length of audio tracks.

### SUMMARY OF THE INVENTION

The present invention relates to both a method and enabling technology used for the systematic creation of new and unique audio compositions.

In one embodiment, the invention encompasses a method for classifying and describing individual audio compositions that facilitates searching a library of individual purpose-composed audio sounds to find sounds that meet desired user criteria. The sounds are created and cataloged in the library in a unique way, such that a non musician user can combine individual sounds from among the library search results that to assemble and mix an audio composition with perfect musical synchrony, and some general (however arbitrary) professional standard of “musical quality” and still meet the user's requirements for certain other stylistic properties.

In one embodiment, the invention encompasses a method for searching a library of these individual purpose-composed audio sounds to find sounds that meet desired user criteria. In another embodiment, the invention encompasses a method selecting sounds from the library according to certain well-defined criteria.

In one embodiment, the invention encompasses a method combining several individual selected sounds into a single audio preview output (or mix), that allows the user to preview the compilation of several individual sounds selected from the library. The invention also encompasses the enabling technology allowing the mixing of these sounds (or Mixer) at the user's workstation web browser with no special software. In additional to adding sounds together, the enabling technology in the Mixer allows adjusting relative volume and other factors for each individual sound. In order to facilitate the preview process, previews deploy versions of the audio library sounds of relatively modest audio resolution that are mixed to compile these preview versions into a single audio output and achieve a desired composition. When a desired composition of layers is compiled, the user can download from the library to the user's workstation either a) very high audio resolution broadcast quality versions of the individual selected layers for subsequent high resolution editing in the user's own digital audio-video editing platform, b) a very high audio resolution broadcast quality version of the mixed composition of layers, or c) both. The library includes both adequate quality (or preview versions) and very high quality (broadcast or performance versions) of each sound. The preview versions, being of lower audio resolution corresponding to smaller file size, enable rapid progress in the audio composition process. The user only downloads the much larger, higher-resolution performance versions of the audio sounds once a desired mix and blend of sounds is achieved. The lower resolution mixes are of low commercial value and cannot be saved locally for any purpose.

In accordance with another embodiment of the invention, method for creation of custom compositions includes a library of individual purpose-composed audio sounds and a computer interface for accessing the library of audio sounds. The computer interface includes a search window for searching the library and selecting audio sounds, and a mixer for mixing the selected audio sounds.

The computer system can be a single computer, or can be a plurality of computers, such as a server and one or more client workstations. The computer system can include a local server that is accessed over a LAN or Intranet, or, the computer system can include a remote server accessed over the INTERNET by personal computers or workstations. Where a server is employed, the server includes the library of audio sounds stored on a storage device, such as an array of DVD drives, and array of CDROM drives, hard disk drives, tape drives, banks of high speed memory, or other digitally accessible storage devices.

In accordance with yet another embodiment of the present invention, a computer system for custom creation of audio compositions includes a server that stores a library of purpose-composed audio sounds in computer readable form. The computer system also includes a communications link connected to the server such that one or more remote workstations or personal computers can selectively connect to the server via the communications link. The workstations or personal computers include, or can download from the server, a computer interface that includes a search window for a user to search the library of audio sounds for desired audio layers. The computer interface further includes a mixer window for a user to mix selected audio layers downloaded from said library. The server further includes tracking means for monitoring all activity of remote workstations in communication with said server. With such tracking means, user activity can be monitored and tracked for record keeping purposes.

In accordance with another embodiment of the invention, a method for searching for pre-compiled mixes of several individual audio sounds (or QuickMix) that are custom compositions included in the library of purpose-composed audio sounds, and a computer interface for accessing QuickMixes in the library of audio sounds.

In accordance with embodiment of the present invention described above a method to view a pre-compiled QuickMix in the browser-based mixer as the individual audio sounds and other factors compiled to create the QuickMix sound, facilitating enhancement, tailoring, adjusting or otherwise recompiling the QuickMix into a new compilation.

In accordance with another embodiment of the invention, a composition creation method includes means for specifying the exact time period in seconds required for the final compiled sound (Spot Generator), without the use of temporal compression or stretching, facilitating the rapid creation of original music compilations of a precise length for artistic, commercial, industrial or other purposes.

In accordance with another aspect of the invention, the invention also includes a system that enables semi-automated, browser-based, database-generation and electronic delivery of documentation (or Cue Sheets) for the purposes of meeting the customary practice of reporting the performance of new compilations created using the invention to so-called Performance Rights Organizations (PROs) such as ASCAP, BMI, SESAC and others.

In accordance with another aspect of the invention, the invention includes a system that enables creation of collaborative managed projects with many compiled mixes using a Program Manager (that includes a computer interface). Using the Program Manager, users can name and save the contents of the mixer at anytime for recall by the user or any designated collaborating user. Saved Mixes, also called Scenes, are organized according projects, also called Programs.

In accordance with another aspect of the invention, a methodology is set forth for the composers to systematically create libraries of individual sounds using an edit block as a foundation for the sounds and layers in the library where the edit block is a specific time length or interval of sound.

### BRIEF DESCRIPTION OF THE INVENTION

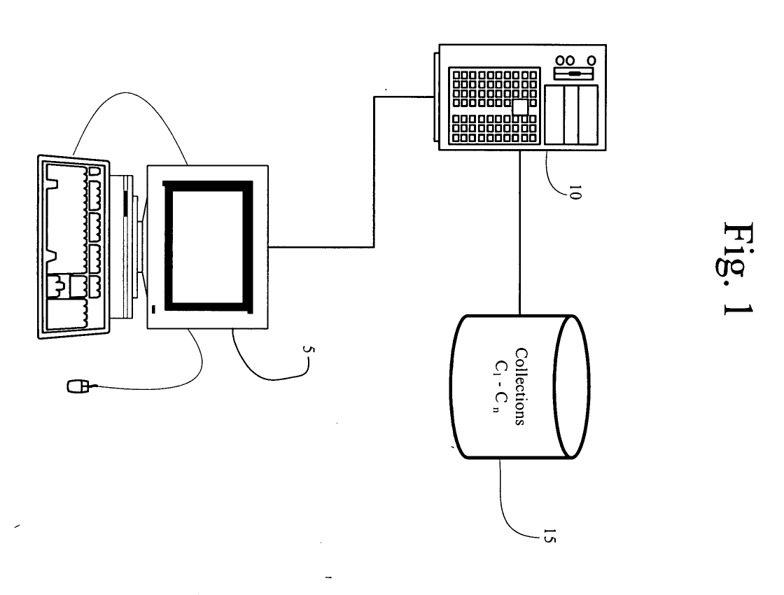

FIG. 1 is a block diagram depicting a single computer that includes a library of audio sounds and a computer interface that allows a single user to access the audio library and thereby construct and audio composition compiled from several audio sounds accessed from the library, in accordance with the present invention.

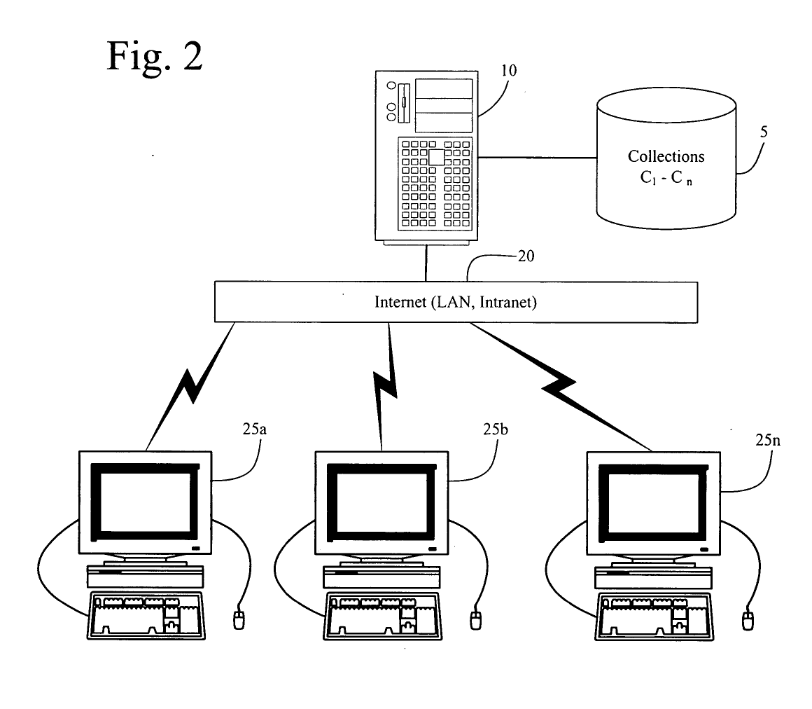

FIG. 2 is a block diagram depicting a computer system that includes a server connected to a library of audio sounds, a communications link, and a plurality of remote computers or workstations that are in communication with the server and the audio library allowing multiple users to access the audio library and thereby construct audio compositions based on audio layers downloaded from the server, in accordance with the present invention.

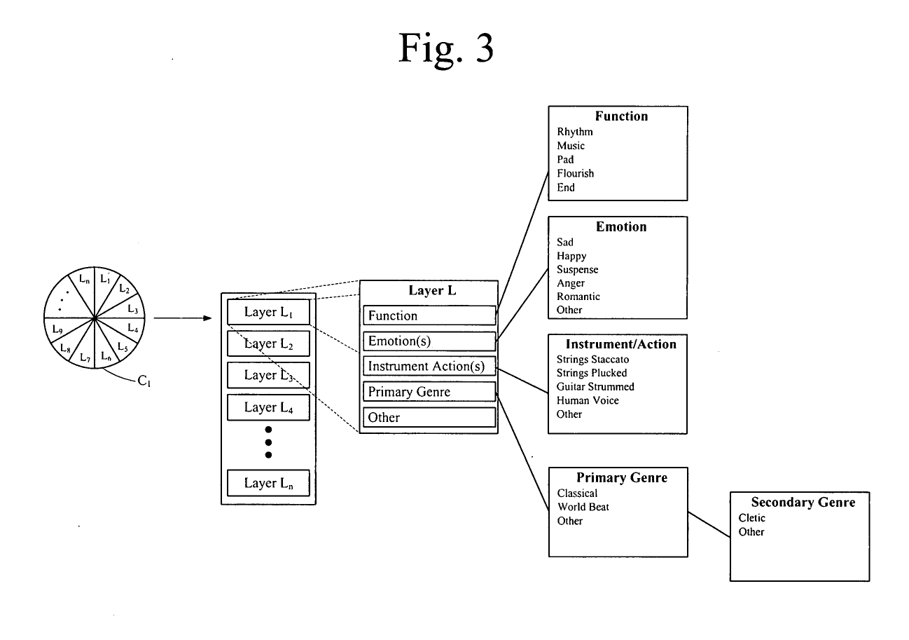

FIG. 3 is a block diagram showing one embodiment of a collection of audio layers in accordance with the present invention.

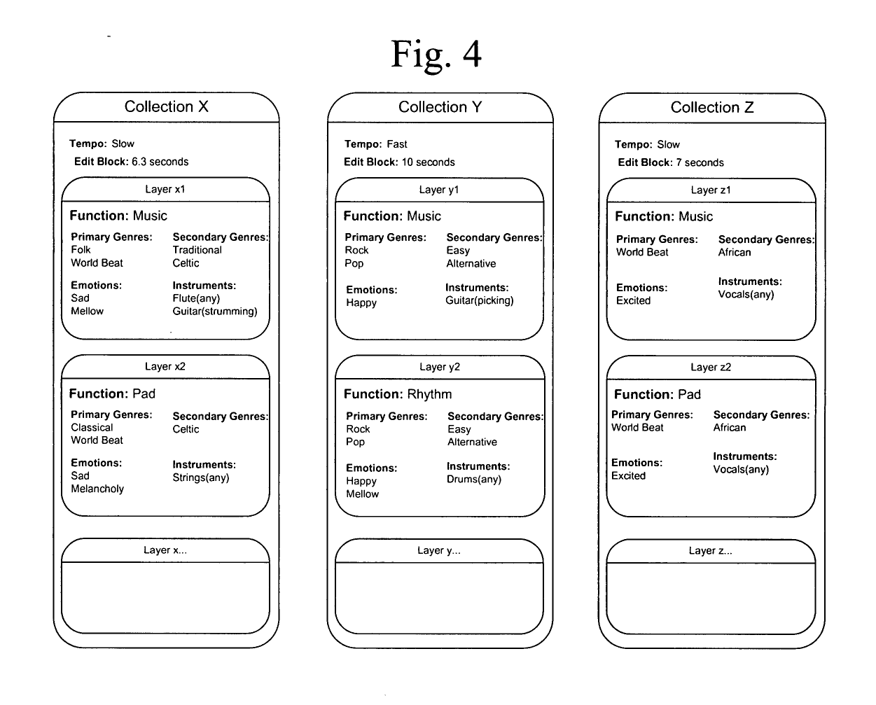

FIG. 4 is a block diagram showing three examples of collections, in accordance with the present invention.

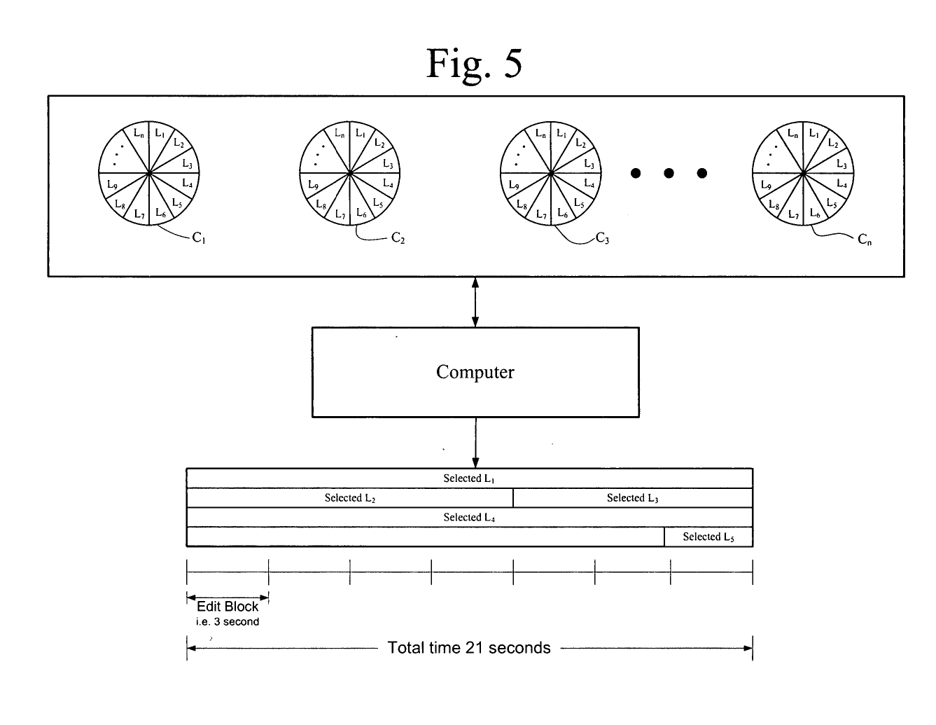

FIG. 5 is a block diagram showing computer-implemented selection of layers from one collection of audio layers, and an assembled composition, in accordance with the present invention.

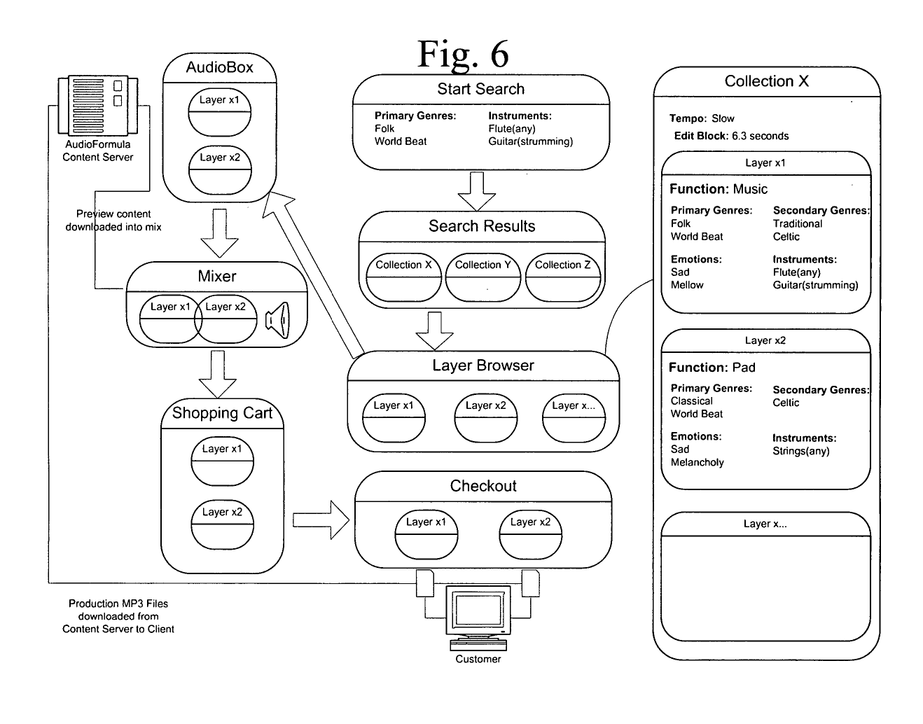

FIG. 6 is a flow chart depicting various steps for construction of an audio composition process that includes searching collections of audio sounds, selecting sounds with desired characteristics, downloading preview versions of the selected sound, mixing the preview versions of the selected layers and then downloading performance versions of chosen layers for creation of a performance version of the audio composition, in accordance with the present invention.

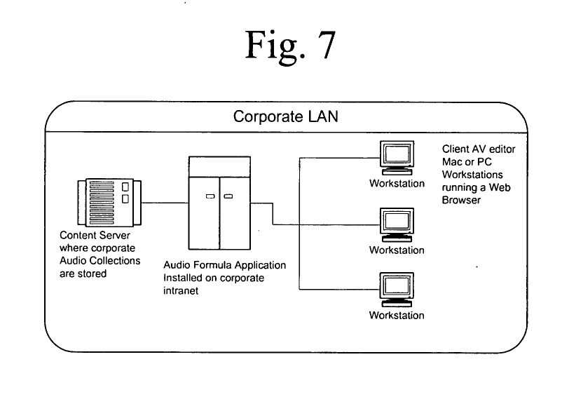

FIG. 7 is a block diagram depicting another embodiment of the present invention implemented over a local area network, in accordance with the present invention.

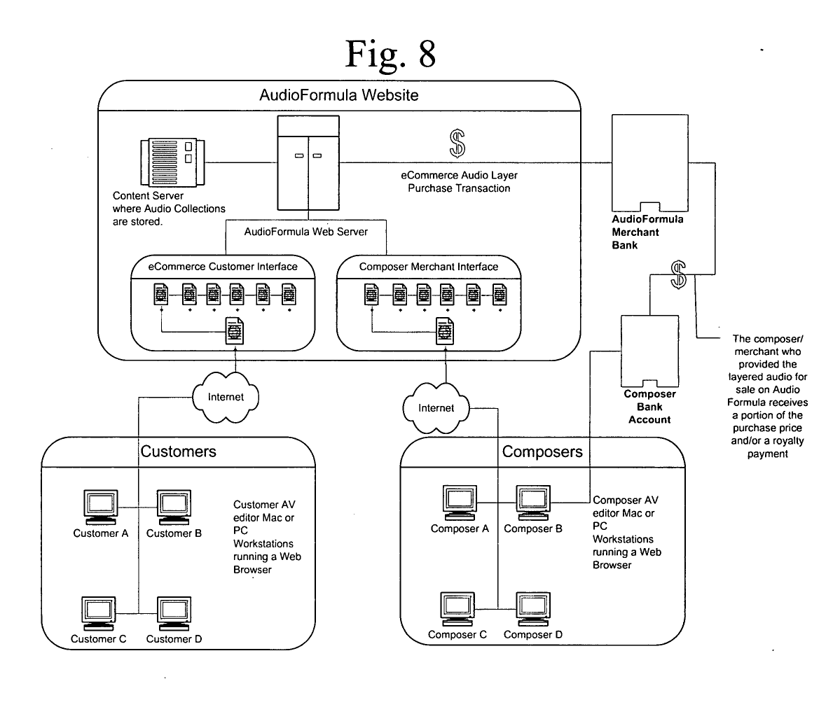

FIG. 8 is a block diagram depicting another embodiment of the present invention implemented over the World Wide Web, in accordance with the present invention.

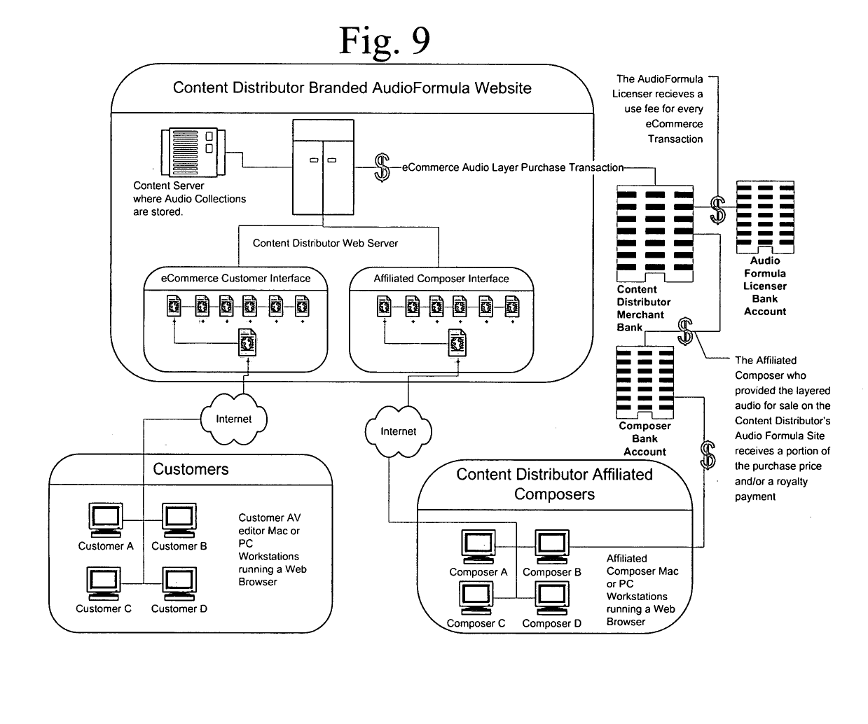

FIG. 9 is a block diagram depicting another embodiment of the present invention implemented over the World Wide Web in the form of a content distributor, in accordance with the present invention.

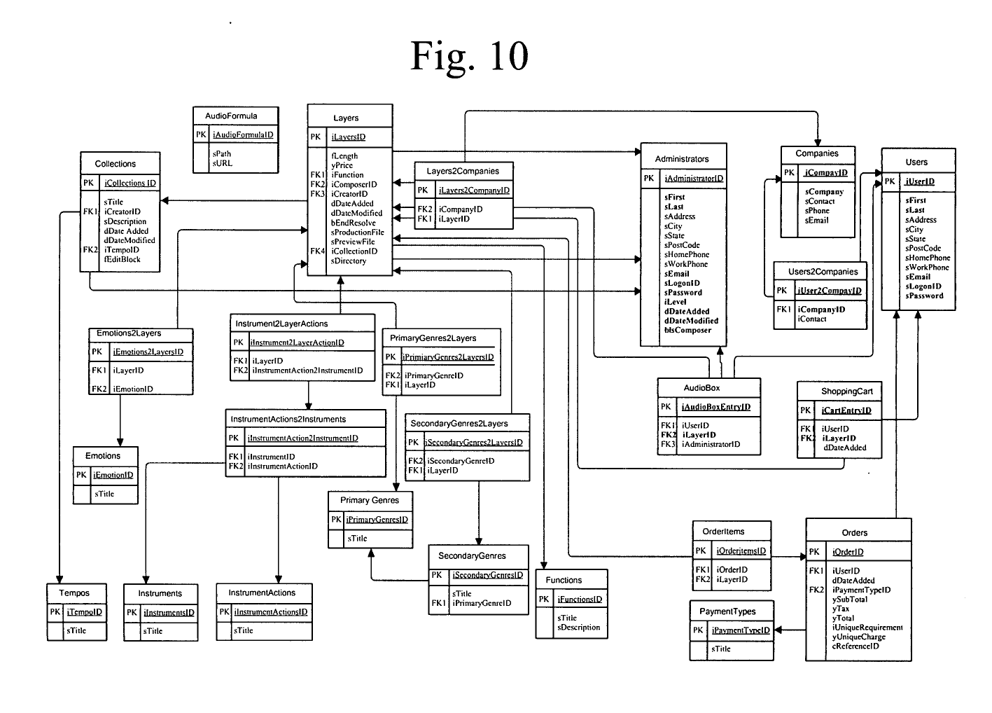

FIG. 10 is a block diagram showing entity relationships of the various data associated with the various audio layers and collections, in accordance with the present invention.

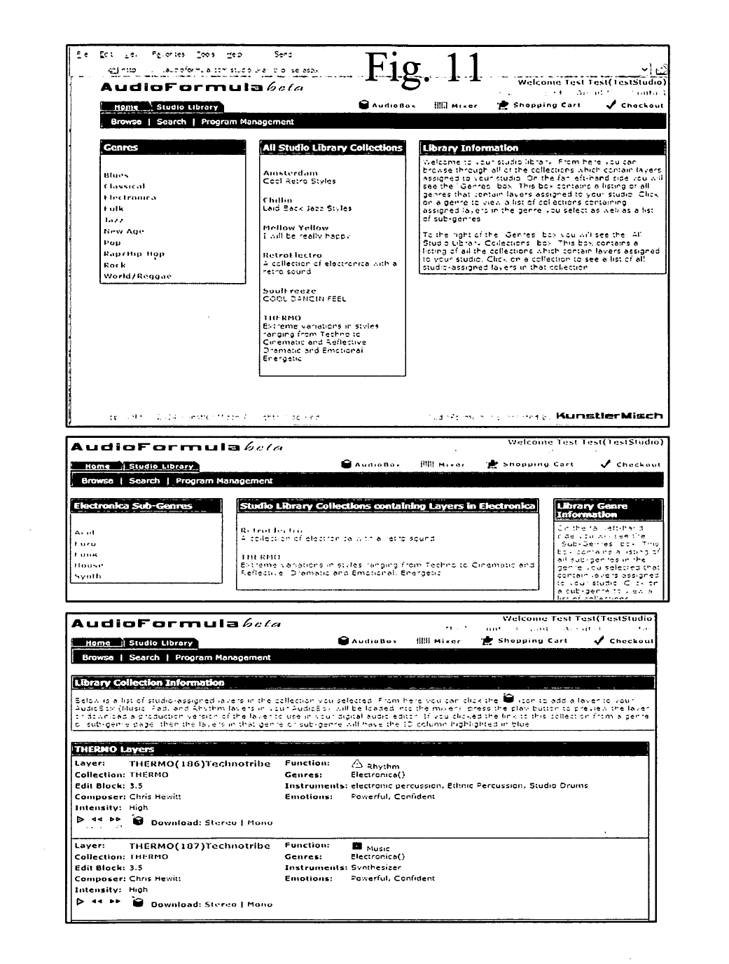

FIG. 11 is a series of computer screen images showing features of a computer interface for searching the audio library for layers that can meet a user determined criteria, and for selecting layers that meet the user determined criteria, in accordance with the present invention.

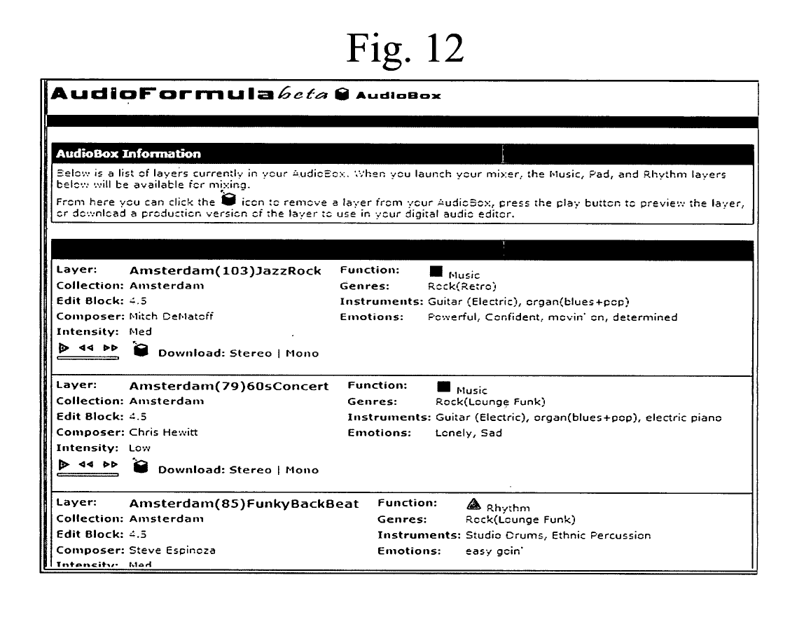

FIG. 12 is a computer screen image showing another feature of the computer interface where selected layers are shown in a computer interface shopping cart for possible downloading for a users use, in accordance with the present invention.

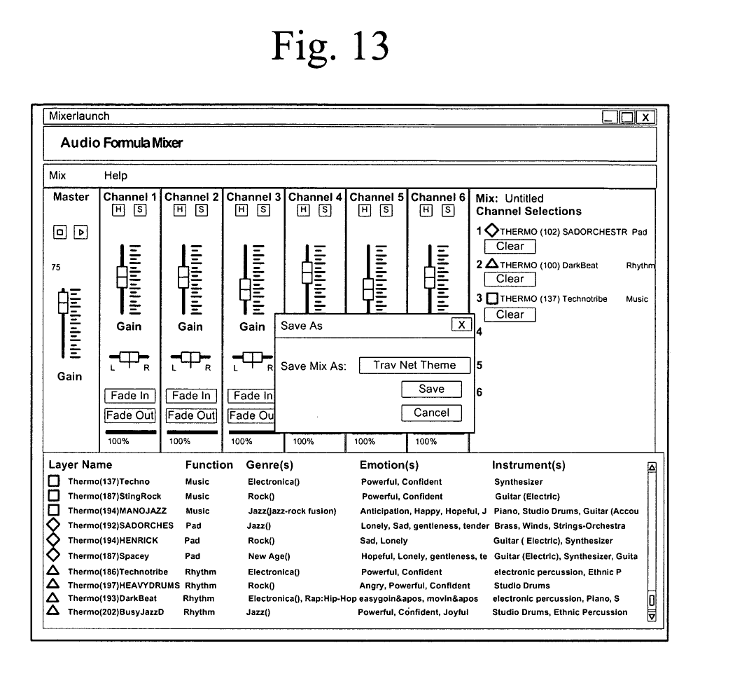

FIG. 13 is a computer screen image showing features of a mixer of the computer interface that allows the user to select layers and mix selected layers to create an audio composition, and save the contents and settings of the mixed composition, in accordance with the present invention.

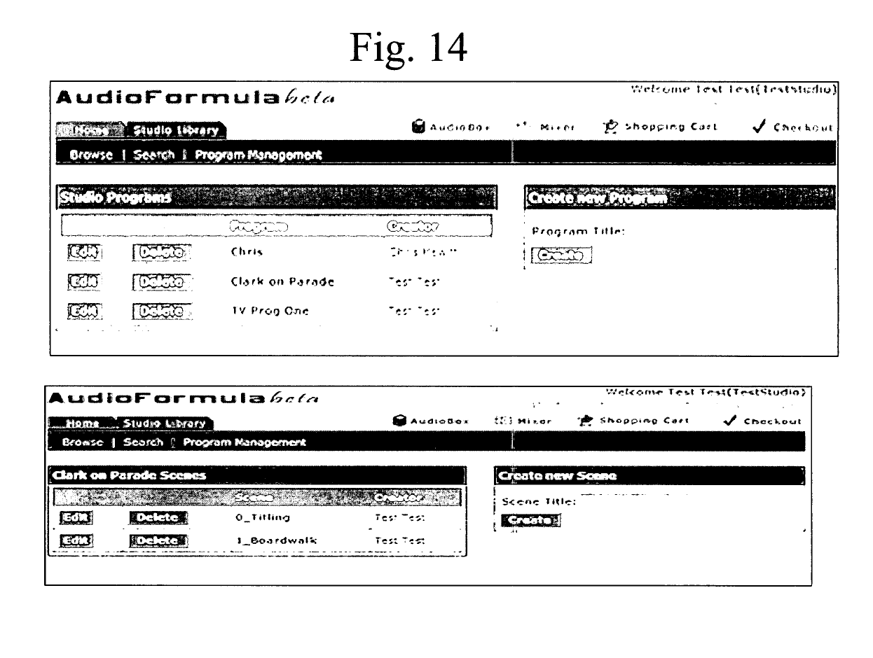

FIG. 14 is a computer screen image of the computer interface showing a Program Management function including organization of mixers, or Scenes, in projects, or Programs, in accordance with the present invention.

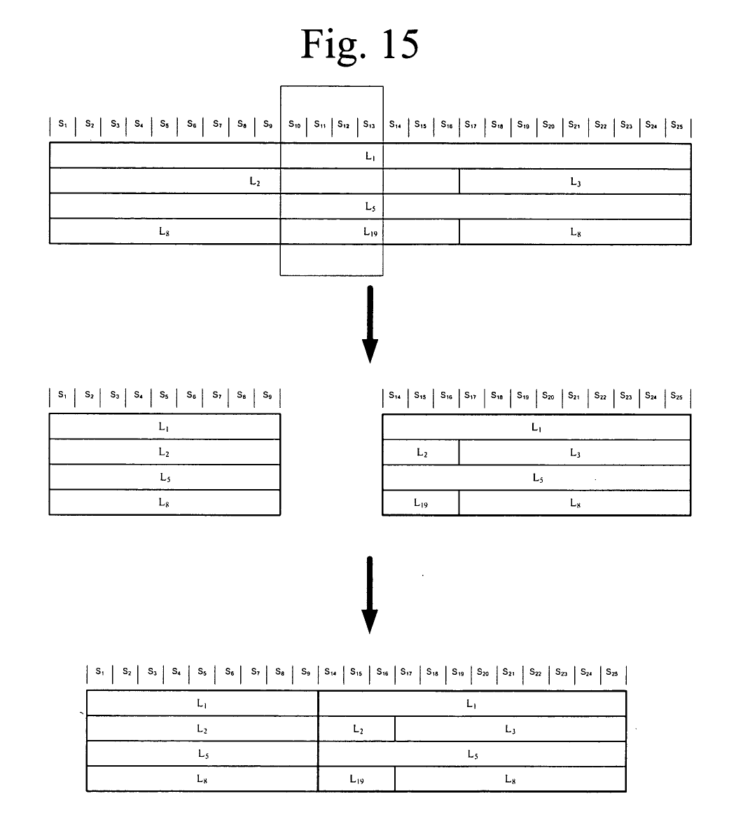

FIG. 15 is a block diagram showing an example creation of a composition, selection of several edit block segments of the composition, deletion of the selected edit block segments and reassembly of the composition without the deleted edit block segments, in accordance with the present invention.

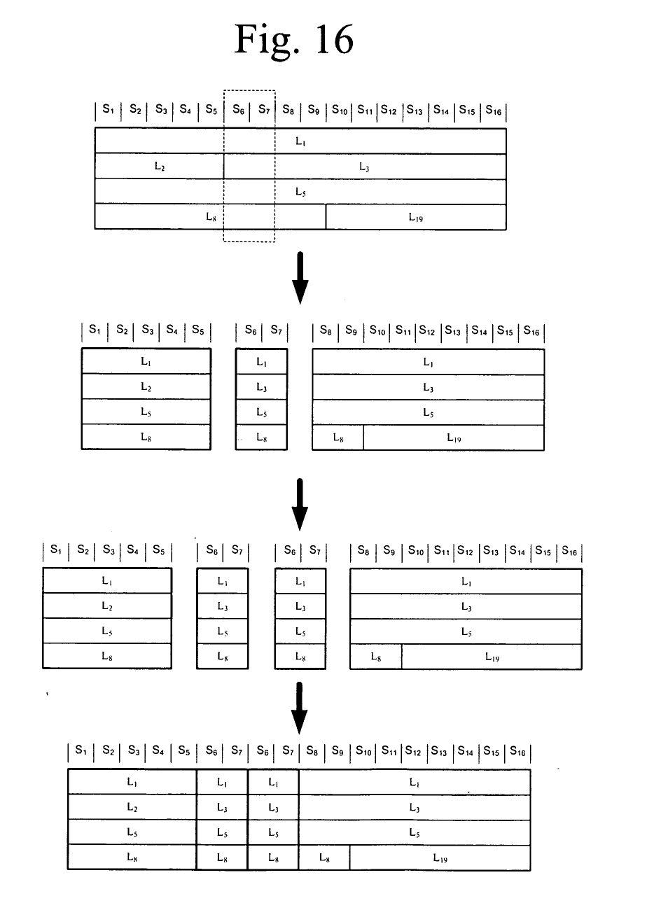

FIG. 16 is a block diagram showing another example of creation of a composition, selection of several edit block segments of the composition, copying and pasting of the selected edit block segments and reassembly of the composition with the pasted edit block segments inserted into the composition, in accordance with the present invention.

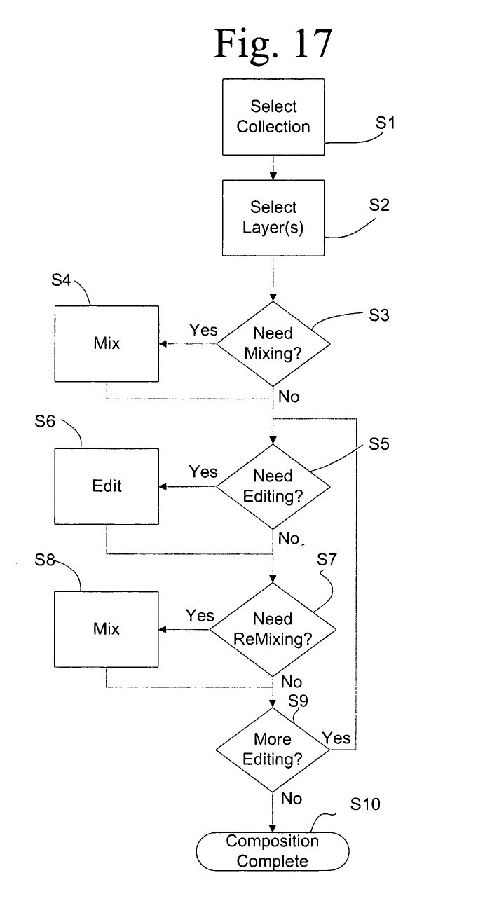

FIG. 17 is a flowchart showing the basic steps for constructing a composition using the computer interface of the present invention.

### DETAILED DESCRIPTION OF THE INVENTIONS

The present invention relates to both method and enabling technology for providing a user with a variety of audio sounds created conforming to a unique method encompasses in the patent, allowing the user to search select and mix desired sounds in order to create a new an unique audio composition for any of a variety of purposes, such as for personal pleasure, for the creation of commercial music and/or for the creation of background music or compositions to accompany a video.

The following definitions are provided to clarify the use of these terms herein.

The terms “audio sounds” “audio files”, “audio layers” and “layer” are used inter-changeably and have generally the same meaning. A “layer” is a pre-determined sound having content, which is preferably of a musical nature that is compatible with other audio layers, as is described in greater detail below. More specifically, layers are contained within collections (defined below) that fall into one of six categories:

(1) Music Layer—defined as pitched elements that include bass to upper midrange instruments. Some light rhythmic non-pitched elements (e.g. a soft high hat or ride cymbal) are permissible (but not necessary).

(2) Rhythm Layer: Non-pitched instruments that define a rhythmic groove.

(3) Pad Layer: Auxiliary or supporting parts that do not include bass notes and includes lower midrange to high pitched notes; some light percussion is also permissible (but not necessary). A Pad can consist of long, quasi-melodic background tones or it can be short guitar plucks and a shaker.

(4) End Resolve Layer: Short ending gestures that contain Musical Elements from the Pad, Music and Rhythm Layers that are used to conclude a piece derived from A Collection.

(5) Quick Mix Layer: A premixed version derived from one set of Music, Pad and Rhythm Layers that are associated with a Collection genre. Quick Mixes do not necessarily include end resolves.

(6) Flourish Layer: Audio files that designed to “hit picture” and create audio transition FX. Flourishes are not tempo or pitch dependent and are usually short sound FX and percussive accents. Flourishes are grouped in Collections that contain Flourishes only; they can be used with music layers derived from other Collections.

The term “collection” herein means an assembly of a plurality of audio layers, all preferably having compatible features. More specifically, a collection is a group of audio files that are purpose composed musical elements. Each component of a collection is called a layer. Each layer is designed as a modular component that can be assembled in any number of combinations enabling the construction of custom compositions. Layers are grouped according to genres or musical styles. Layers have different functions in the creation of music that a user derives from a collection, as is described in greater detail below.

The term “library” herein means a plurality of collections of audio layers that are searchable by a computer, as is described in greater detail below.

The term “computer” and “computer system” are used interchangeably herein and mean one or more computers in communication with one another for searching and transmitting the libraries of collections of audio layers, or single computer with access to data storage device(s). Further, a computer can be a workstation accessing a mainframe or a desktop computer with any chipset or platform, such as Apple's Macintosh computers, Intel®/Windows® based computers or Linux® based computers.

The term “software” herein means computer-implementable instructions for effecting the various embodiments of the present invention, regardless of where that software resides. For instance, the software can be loaded into the memory of a computer, or computes, it can be stored on an electronic storage device, such as electronic memory, a hard drive, a CDROM drive or CDROM disk, DVD drive, DVD disk, or other transportable software carrying media.

The term composition herein means an assembled collection of audio layers, put together at a user's discretion from selected audio layers identified by searching the library of audio layer collections using the present invention. The terms composition and production file are used interchangeably herein, however generally a composition is a completed work and the production file is a composition being edited and changed. Specifically, a production file is a compilation of layers or audio files that are downloaded for use in the editor within the computer interface of the present invention, mixed, edited and remixed to form the composition. The layers and subsequent composition is downloadable in high quality mp3 or AIFF, stereo or mono 16 bit 48k format.

In a first embodiment of the present invention, as generally depicted in FIG. 1, a computer system is provided that includes a work station [5] that is connected to a server [10] that includes a library [15] of audio file collections. The library [15] and the audio file collections are described in greater detail below. It should be understood, that the stand-alone system depicted in FIG. 1 can be a single computer with a monitor, keyboard and mouse, or can be a personal computer connected to a server. It should be understood that the library [15] is stored on a computer readable storage device, such as one or more DVD recorders/players, CDROM recorders/players, hard drives, electronic memory storage devices or other such storage media. The storage devices holding the library [15] can be physically located in workstation [5], the server [10], or can be an external storage device separate from the server [10]. Operation and use of the computer system depicted in FIG. 1 are described in greater detail below.

In a second embodiment of the present invention depicted in FIG. 2, the server [10] again includes the library [15]. The server [10] is connected to a communications link [20] that can be any of a variety of communication technologies, such as the INTERNET, a local area network (LAN) or an intranet. In the case where the communications link [20] is the INTERNET, access to the server [10] is effected by modem, T1, DSL or other direct communications devices. One or more computers or workstations [25a, 25b through 25n] can log on the server [10] in a manner described in greater detail below for the purpose of searching the library [15] for desired audio sounds, selecting appropriate sounds, and mixing those sounds in order to create a new and unique audio composition, as is described in greater detail below.

FIG. 3 depicts, generally, one embodiment of invention is an organizing principle of the collection of audio layers. The collection is an ensemble of sounds, hereafter referred to as layers. Each collection, as depicted in FIG. 3, consists of an indeterminate number of layers that varies from collection to collection. Some collections can have 10 to 20 layers; other collections can have hundreds or thousands of layers, depending upon the composer assembling the collection. Each member layer of a collection must share two common musical features: tempo and interval correlated to an edit block which is described in greater detail below. The tempo is the “speed” of the layer (e.g., very slow, slow, moderate, fast, very fast, corresponding to beats per minute). The interval, also called the Edit Block, is a unit of phrase editing time equal to the tempo required to create whole number durations of two measure blocks of musical time. The use of tempo and interval, or Edit Block, is a new and unique classification method that provides a foolproof process for non-musicians to create high quality, harmonious and completely synchronous multi-layer compositions with more than adequate temporal precision for High Definition Audio and Video. Each of the layers in a collection is preferably composed, constructed and assembled based upon the interval of the edit block.

In the collection shown in FIG. 3, the collection has layers L₁ through Lₙ layers. In a preferred embodiment, each of the layers L in a collection has properties associated with it. Each layer L is unique, so the properties associated with each layer can differ with the properties of other layers in the collection. A list of each of the types of properties of each layer L is depicted on the center of FIG. 3. For instance, each layer has a function, an emotion, an instrument action and a primary genre. However, it should be understood that, as depicted in FIG. 3, there can be other function designations. Generally each layer has only one function, one emotion, one instrument action, and one primary genre. Examples of each of the types of properties are shown on the right hand side of FIG. 3.

Examples of layer functions include: rhythm, music, pad, flourish and end resolve. However, there can be other functions. Layers with the function “rhythm” are typically percussive in nature and provide a basic rhythmic backbone to any subsequently built audio composition. For instance, layers with the function “rhythm” can be drum audio sounds, and/or other percussive instruments. However, it should be understood that a layer with a rhythm function need not necessarily be a percussion instrument, but can be any instrument that provides, suggests or implies a rhythm without a melody.

Layers with the function “music” generally define a melody line or a lead line that can, with other layers, define a melody. Such layers can be single instruments or combinations of instruments. Such layers can also be a single note, combinations of notes, partial tonal phrases, or a complete tonal phrase, depending upon the designs of the composer.

Layers with the function “pad” generally define a chordal structure and can be any of a variety of instruments and voicings. For instance, a pad can be monotone, dual tone, triads, sevenths, ninths, etc., depending upon the creative nature of the composer. The “pads” can be harmonious or include dissonance, depending upon the designs of the composer.

Layers with the function “flourish” are generally short accentuating audio sounds such as a cymbal crash, a string flourish, a crescendo or other accent that highlights a portion of a musical piece.

Layers with the function “end resolve” are sounds that typically end a piece of music or audio composition with a flourish or other accentuation.

Each layer is also assigned an emotion (or Intensity). Examples of emotions include sad, happy, party, excitement, thoughtfulness, suspense, anger, fright, romantic, as well as other emotions.

Each in a collection can also be assigned a combined instrument-action property, such as piano-staccato, violin-plucked, guitar-strummed, cello-bowed, etc.

Each layer is designated by a primary genre, such as folk, world beat, rock, pop, classical, etc. Each layer can also be designated by a secondary genre, such as under the primary genre of folk, the secondary genre can be traditional. Other secondary genres further expand on the primary genre to assist a user in identifying layers that fit a desired final sound for an audio composition.

FIG. 4 shows an example of three collections, Collection X, Collection Y and Collection Z, which together define a simple example of a library, in accordance with the present invention. Each collection has its own tempo and edit block interval, where the edit interval is as mentioned above, a length corresponding to a rhythmic cycle.

In one embodiment of the present invention, as depicted in FIG. 5, a user uses a computer to search and select layers to construct an audio composition. The audio composition can include at least one or more of the following: a selected rhythm layer L₁, a first selected music layer L₂, a second selected music layer L₃, a selected pad layer L₄, and an end and/or flourish layer L₅. Although it should be understood that several rhythm layers can be used either in a single audio composition with the layers being played in succession, one after another, or layered one on top of one another in the final mix. Similarly, combinations of pad layers, music layers, flourishes and end resolves can be used. The present invention is not limited to one and only one type of layer being used in a single final audio composition. The Edit Block concept that is integrated into collection design allows linear (in time) and vertical (in number of layers) recombining and repurposing of layers from a Collection, so that a Collection of several Layers can yield an infinite number of musical permutations, with the option of seamless musical edits, without special or additional software installed in the End User's workstation.

The inventors have provided a name to the computer system of the present invention: The AudioFormula™ Content Repository, or AFCR. The AFCR is organized into the above described collections. Each collection is an ensemble of audio files, or layers, that share common tempo (e.g., fast, medium, slow), and Edit Block. The Edit Block is the number of seconds that is a “quantum” length of audio where new layers from the same collection can be added without compromise to the synchrony of the combined audio layers.

As mentioned above, every layer has at least FOUR descriptive properties: FUNCTION is the composer's intended role for the layer, such as RHYTHM, MUSIC, PAD, FLOURISH, END RESOLVE. In a preferred embodiment of the present invention, a Layer does not generally possess more than one function. EDIT BLOCK is a unit of phrase editing time equal to the tempo required to create one-tenth second durations of two measure blocks of musical time. INTENSITY is the composer's intended emotive classification of the layer such as HAPPY, TENSE, SAD, ANGRY. A layer can have more than one emotion. PRIMIARY GENRE is the composer's classification of the musical family such as ROCK, CLASSICAL, JAZZ, and HIP HOP. A layer can have more than one primary genre. Layers can also be assigned a SECONDARY GENRE, which is the sub class of the primary genre. Each secondary genre “belongs” to one primary genre. For example, the JAZZ primary genre can have the secondary genre of SWING, MODERN, FUNK, and IMPROV. The FUNK secondary genre cannot belong to any other primary genre. A layer can have multiple secondary genre with the restriction that the layer is assigned the appropriate parent primary genre as well. Layers can also be assigned an INSTRUMENT-ACTION, which is the composer's description of the instrument or sampled sound featured in the layer such as HUMAN VOICE, BASS GUITAR or PIANO, combined with the articulation of the audio source in laymen's terms, such as HUMMING, THUMBING, STRUMMING, or in more formal terms, such as STACCATO, PIANISSIMO, PIANO, MEZZO, MEZZO PIANO, MEZZO FORTE, FORTE, FORTISSIMO, etc. Tempo and/or the rhythm audio layers can be categorized in layman's terms, FAST, ROCK, SLOW, etc., or can be defined in more traditional terms, such as LARGO, LENT or LENTO, ADAGIO, LARGHETTO, ANDANTE, ANDANTINO, MODERATO, ALLEGRETTO, ALLEGRO, VIVO, VIVACE, ALLEGRO, PRESTO, etc.

In one embodiment of the present invention, as depicted in FIG. 5, a user uses a computer to search and select layers to construct an audio composition. The audio composition can include at least one or more of the following: a selected rhythm layer L₁, a first selected music layer L₂, a second selected music layer L₃, a selected pad layer L₄, and an end and/or flourish layer L₅. Although it should be understood that several rhythm layers can be used either in a single audio composition with the layers being played in succession, one after another, or layered one on top of one another in the final mix. Similarly, combinations of pad layers, music layers, flourishes and end resolves can be used. The present invention is not limited to one and only one type of layer being used in a single final audio composition.

In one embodiment of the present invention, an audio composition is constructed generally following the steps depicted in FIG. 6. Users create Audio Music by mixing together audio layers that typically belong to the same collection, but can search and select from different, but similar collections. As shown in the center of FIG. 6, a user supplies search criteria including but not limited to emotions, instrument/action combinations, primary genres, secondary genres, and tempo. A computer interface shows the search results by depicting a representation of any collections which contain audio layers that match the search criteria. Using the computer interface, the user(s) select the collection they wish to preview using a layer browser, which is part of the interface. One embodiment of the enabling technology in the invention is the Layer Browser. The layer browser shows all layers in a chosen collection or collections. The organization of the layers view is configurable by the user. Users select layers from a collection that they wish to mix and preview in a temporary holding area called the AudioBox™. The AudioBox™ of the present invention is similar in function to the typical e-commerce shopping cart, except that the AudioBox™ contains references to the audio layers a customer wishes to preview in the mixer, and not layers the customer intends to purchase. By clicking a mixer icon within the AudioFormula interface, another enabling technology feature, the AudioFormula™ Mixer utility is launched. The Mixer utility is either installed on the users computer, downloaded from a server into the users computer or used as a browser-based client server application (identified in FIG. 6 as Customer) for use in the present invention. The Mixer is used to compile selected audio layers in the user's AudioBox™ into audibly preview compositions. Once the user has found the ensemble of layers that suit their purpose, the user can flag these selected layers for download (and purchase). The user can download a) individual layers high resolution, broadcast quality audio layers in a range of formats such as, MPEG-2 layer 3 (a.k.a. mp3), Waveform audio (WAV or RIFF WAVE format), Audio Interchange File Format (AIFF), AIFF with proprietary encoding such as Garage Band®, Apple Loops®, AIFF Compressed (AIFC), and others formats for subsequent editing with the user's digital audio-video editor platform, b) a single high resolution, broadcast quality audio file of the compiled ensemble of layers in the mixer in a range of formats such as, MPEG-2 layer 3 (a.k.a. mp3), Wave, Audio Interchange File Format (AIFF), AIFF with proprietary encoding such as Garage Band®, Apple Loops®, AIFF Compressed (AIFC), and others, or c) both.

In one embodiment of the present invention, the AudioFormula™ application software resides and is executed on a server, and the computer interface to AudioFormula™, including selection, mixing and previewing audio selections prior to download takes places inside the user workstation web browser “container” with no software installed on the user workstation. Audio files for preview with the mixer utility are low resolution and cannot be saved locally with the user.

As shown in FIG. 7, the present invention can be used in a small setting in a corporate edition over a Corporate LAN (local area network). AudioFormula™ can be installed on a private corporate intranet for a license fee. The AudioFormula™ application is installed in the network operations center running on a server connected to the corporate intranet. Corporate Audio Video Editors use AudioFormula™ application and company audio content repository directly over private intranet, or outside the corporate LAN using VPN or other remote access technology. The PC or MAC only requires LAN access and a web browser with, for instance, the Macromedia® FLASH® plug-in. No additional software is required to use AudioFormula™.

Authorized composer accounts can be created by the system administrator. Authorized composers can access the AudioFormula™ installation with directly over private intranet, or outside the corporate LAN using VPN or other remote access technology. The PC or MAC only requires LAN access and a web browser with the Macromedia FLASH plug-in. No additional software is required to use AudioFormula™ enabling technology. Authorized composers can upload additional layered audio content into the content repository using the AudioFormula™ application.

Alternatively, as shown in FIG. 8, the present invention can be implemented from a website over the internet.

As shown in FIG. 8, The AudioFormula™ online application is available to individual customers on the AudioFormula™ web site through the World Wide Web. Composers can create merchant accounts to sell their layered audio to customers using the AudioFormula™ online application.

In one embodiment, individual customers use the AudioFormula™ online application and audio content repository directly over the World Wide Web. The PC or MAC only requires internet access and a web browser with the Macromedia FLASH plug-in. No additional software is required to use Audio Formula. The AudioFormula™ online application runs on the AudioFormula™ Server. Audio layers can be purchased using ecommerce transactions.

Composers can create merchant accounts using the AudioFormula™ online application to sell the layered Audio they create. Composers upload layered audio content (i.e., new collections of layers) to the AudioFormula™ Content server using the AudioFormula™ application. The composer sets the price for use and tentatively classifies the layered audio content. When the content is purchased and downloaded by a customer, the royalties and or purchase price percentages are sent electronically via ACH to the composer's bank account.

In another embodiment of the present invention depicted in FIG. 9, a Content Distributor Branded AudioFormula™ online application is made available to individual customers on the Content Distributor web site through the World Wide Web. Affiliated Composers upload layered audio (i.e. layers and collections of layers) to be sold through the Content Distributors AudioFormula™ website.

Individual customers use the Content Distributor Branded AudioFormula™ online application and audio content repository directly over the World Wide Web. The PC or MAC only requires internet access and a web browser with the Macromedia FLASH plug-in. No additional software is required to use Audio Formula. The Content Distributor Branded AudioFormula™ online application runs either on the Content Distributor's Server or a server provided by the AudioFormula™ Licensor. Audio layers can be purchased using ecommerce transactions.

Affiliated Composers upload layered audio content to the Content Distributor's AudioFormula™ Content server using the Content Distributor's AudioFormula™ application. The composer sets the price for use according to the Content Distributor's guidelines and tentatively classifies the layered audio content. When the content is purchased and downloaded by a customer, royalties and or purchase price percentages are sent electronically to the composer's bank account, and a use fee is deposited into the AudioFormula™ Licensor's bank account.

FIG. 10 shows one embodiment of entity relationships of the various data entities associated with the various audio layers and collections. It should be understood that the tables of data related to the audio layers can be organized in any of a variety of ways. The organization depicted in FIG. 10 is only one example of such organizational relationships.

As shown in FIG. 10, the various tables of data are interlinked in a robust and logical manner. One table of data labeled Collections includes critical data related to each collection of layers. For example, the data includes the title, creator, a description of the collection, dates added and modified, the tempo and edit block specification. Related data tables include information required to store and access the layers in a collection, emotions of each layer, instrument action of each layer, genres, function, and other information. FIG. 10 also shows business related data such as cost, user account information, royalty information, composer information, order information and other information important for operating the present invention as a business.

FIG. 11 is a screen dump showing examples of a browser computer interface for searching the layer collections and selecting layers for preview. A user operating the computer interface first looks at a list of genres to determine the general category of collections that might suit his or her needs. Once a genre has been highlighted, information concerning appropriate collections appear on the screen. As shown in the center screen, once a genre has been selected a sub-genre can be displayed to provide the user with more specific selections. Finally, at the bottom of FIG. 11, specific information regarding layers that fit the selected user genre and sub-genre criteria are displayed to enable the user to select suitable layers for composition construction.

FIG. 12 is a screen dump showing an image of the computer interface displaying selected layers a user is ready to download. The selected layers are displayed in the AudioBox window of the computer interface of the present invention, which serves as a temporary holding space for layers the users wishes to mix inside of the AudioFormula mixer.

FIG. 13 is a screen dump showing one example of a browser mixer of the computer interface of the present invention showing the mixer control functions and save features. In FIG. 13, layers selected by a user are loaded into different channels, each channel being displayed with a virtual volume slider, one channel for each layer selected. The user operates the sliders using the mouse or pointer device of the computer to adjust the sound level of each layer to achieve a desired composition mix. The contents and settings of a mix can be saved for recall by the user or designated collaborating users.

Once layers have been selected and a composition has been constructed, the user can further manipulate the composition to suit the needs of the project. For example, by using the computer interface, the final composition can be further edited using the above mentioned edit block features of the present invention. A visual representation of the composition is displayed on the computer interface and portions of the composition can be selected for cutting and deleting to shorten a composition, or cutting and pasting to lengthen or otherwise fine tune a composition.

Examples of editing a composition are depicted in FIGS. 15 and 16 showing the advantages of the Edit Block construction of the layers. In FIG. 15, for instance, a composition has been constructed using selected layers L₁, L₂, L₃, L₅, L₈, L₁₉ and a second occurrence of L₈. As can be seen at the top of FIG. 15, the composition has a length of twenty five time intervals or edit blocks S₁-S₂₅. The user has determined that the composition is too long and has selected segments S₁₀-S₁₃. In the center portion of FIG. 15, segments S₁₀-S₁₃ are deleted using the computer interface, and at the bottom of FIG. 15, the composition is reassembled without segments S₁₀-S₁₃. The composition has been shortened by four edit block lengths.

In another example of the ease of editing a composition is depicted in FIG. 16 where a composition has been constructed using selected layers L₁, L₂, L₃, L₅, L₈ and L₁₉. As can be seen at the top of FIG. 16, the composition has a length of sixteen time intervals or edit blocks S₁-S₁₆. The user has determined that the composition is either too short or desires that a portion of the composition be extended and has selected segments S₆ and S₇. In the second portion of FIG. 16, segments S₆ and S₇ are copied using the computer interface, and in the third portion of FIG. 16, segments S₆ and S₇ are pasted such that segments S₆ and S₇ occur twice in succession. At the bottom of FIG. 16, the composition is reassembled with both occurrences of segments S₆ and S₇. The composition has been lengthened by the addition of two edit block lengths. It should be appreciated that the compositions shown at the top of FIGS. 15 and 16 are the product of previous editing by cutting and pasting. Specifically, the composition at the top of FIG. 15 was previously cut and pasted in order to have a portion of layer L₁₉ be included at edit block segments S₁₀ through S₁₆. Similarly, the composition at the top of FIG. 16 was previously cut and pasted in order to have a portion of layer L₃ be included at edit block segments S₆ through S₁₆.

As long as the edits are made maintaining each edit block segment length within the composition, the assembled portions of the composition will perform continuously and smoothly with no noticeable disruption in the flow, sound and feel of the composition, since all layers are composed and designed to conform to the edit block length. However, should a user desire a discontinuity in a composition, by selecting appropriate layers such discontinuity can be a part of a composition.

Referring now to FIG. 17, the above described computer interface is used to first, select a collection as indicated in step S1. Once a collection has been selected based upon emotion, genre or other criteria, the user reviews layers and selects audio layers, as indicated in step S2, to begin constructing a production file. The selected layers of the production file are accessed by the computer interface and can now be mixed if necessary. If mixing is required, the user selects mixing, as indicated in step S3 and mixes the various layers using the mixer depicted in FIG. 13 to achieve a desired overall sound as indicated at step S4. When mixing is complete, the production file may require editing, depending upon the user's requirements. At step S5 the user can select editing. Editing is performed using the computer interface, as indicated at step S6, and as demonstrated in the examples shown in FIGS. 15 and 16. When editing is complete, the user can choose more mixing using the computer interface, as indicated at step S7 and S8, further editing at step S9, or the final composition can be produced and downloaded as indicated at step S1.

In a preferred embodiment, the audio layers in the collections described above, are carefully crafted by composers, who construct various layers so that others can combine selected layers to create new and unique audio compositions for use in any of a variety of settings, such as background music, video soundtracks, and original musical compositions, all by searching, selecting and mixing audio layers with desired sound qualities. Users get the satisfaction of creating their own compositions, and the composers who create and compile the audio layer collections have an outlet for their creativity as well.

The present invention also relates to the construction of layers and collections used with the above described computer interface and data library of collections. The following steps provide composers who are composing, designing and constructing layers the means for completing collections used in accordance with the present invention.

First, a composer creates a collection by following certain guidelines.

Step One: Determine the Purpose and Function of Your Collection.

Each collection can contain a wide variation of styles, but preferably has more subtle stylistic changes and evokes specific emotions, some more intense, some less intense. For example, a collection can conform to a specific musical style such as characteristic period radio studio orchestra, i.e., Glen Miller Big Band jazz, Bing Crosby Style Pop, etc. that allows the user to vary seamlessly between different moods and stylistic inflections. Other examples of specific genres of collection can be ancient styles, such a Gregorian Chant, or a Baroque/Classical genres, or a 20's, 60s, 70s, or 80s feel, etc. Each collection can be different and unique. However, as set forth above, each collection conforms to certain parameters that make each layer within the collection usable in one form or another with each of the other layers within that collection. The content of a collection is determined by the composer.

Step Two: Choose a Tempo, Time Signature and an Edit Block.

A single edit block is common to all layers in a collection. The edit block is dependent upon the time signature and tempo of the layers in that collection. Edit blocks are used to define cut and paste points to edit music layers. Edit blocks can be categorized in 1/2 second increments starting at two seconds. An edit block can also equal to exactly 2 measures of “music” time—eight beats of 4/4, six beats of 3/4, ten beats of 5/4, etc. This doesn't mean the music composed has to always be “even and square” with two of four measure phrases. But each collection can have only one edit block, one tempo and one time signature and the Collection tempo much be chosen from a fixed set of values corresponding to different time signatures. However a wide variety of tempos are possible (the collection time “feel”—”—i.e., straight 16ths. swing 8ths, etc., is determined by the collection designer, i.e. the composer). Here are some examples: a collection in 4/4 with a 3.5 second Edit Block has a tempo of 137.17 bpm; a 4/4 Collection with 4 second Edit Block is at 120 bpm; and a 4/4 Collection with a 4.5 sec edit block is 106.66 bpm. Again the tempos associated with edit blocks are also time signature dependent and can easily be computed. In the table below, more examples are provided.

TABLE 1
EDIT BLOCK TEMPOS: SEQUENCE SET AT 30 FPS n/d,
LAYER AUDIO BEGINS AT 1:00:00:00
Audio Layers and Sequence Settings Specs

| Edit | End | File | Edit | | |
|---|---|---|---|---|---|
| Block | Resolve | Length | Blocks | Total | |
| (seconds) | (SMPTE) | (AudioLayers) | Total | Measures | BPM 4/4 |
| 2.0 | 1:01:30:00 | 90.00 sec | 45 | 90 | 240.00 |
| 2.5 | 1:01:30:00 | 90.00 sec | 36 | 72 | 192.00 |
| 3.0 | 1:01:30:00 | 90.00 sec | 30 | 60 | 160.00 |
| 3.5 | 1:01:31:00 | 91.00 sec | 26 | 52 | 137.14 |
| 4.0 | 1:01:30:00 | 90.00 sec | 22.5 | 45 | 120.00 |
| 4.5 | 1:01:30:00 | 90.00 sec | 20 | 40 | 106.66 |
| 5.0 | 1:01:30:00 | 90.00 sec | 18 | 36 | 096.00 |
| 5.5 | 1:01:28:00 | 88.00 sec | 16 | 32 | 087.27 |
| 6.0 | 1:01:30:00 | 90.00 sec | 15 | 30 | 080.00 |
| 6.5 | 1:01:31:00 | 91.00 sec | 14 | 28 | 073.84 |
| 7.0 | 1:01:31:00 | 91.00 sec | 13 | 26 | 068.57 |
| 7.5 | 1:01:30:00 | 90.00 sec | 12 | 24 | 064.00 |
| 8.0 | 1:01:28:00 | 88.00 sec | 11 | 22 | 060.00 |

Step Three: Plant the Seed Layers for the Collection

In the construction of a collection a first step is the creation of base layers, hereinafter referred to as the seed layer. The seed is the foundation for all other musical layers created in a collection and are usually the first layers composed. The seed layers are the standard by which all other collection components (i.e. layers) are cross-referenced. The creation of the seed layer is up to the personal working style of the composer, but the fundamental components required are the same across the board: Each seed is a preferably a complete musical piece, usually about 1.5 minutes in length, that contains a “stem” structure of four layers:

(1) Music Layer—defined as pitched elements that include bass to upper midrange instruments. Some light rhythmic non-pitched elements (e.g. a soft high hat or ride cymbal) are permissible (but not necessary).

(2) Rhythm Layer: Non-pitched instruments that define a groove. This is the Collection Designer's call depending on the style of music.

(3) Pad Layer: Auxiliary or supporting parts that do not include bass notes and includes lower midrange to high pitched notes; some light percussion is also permissible (but not necessary). A Pad can consist of long, quasi-melodic background tones or it can be short guitar plucks and a shaker.

(4) End Resolve Layer: Short ending gestures that contain Musical Elements from the Pad, Music and Rhythm Layers; Audio Formula categorizes each End Resolve according to its length (Short, Med, Long and Fade out). Moreover, End Resolves can offer different emotional conclusions to the music derived from a Collection. Each Pad, Music and Rhythm Layer preferably works in concert with each other (i.e., if played simultaneously, they sound good.) Also, they each preferably are able to function as a standalone accompaniment to a scene without any other layers playing. Preferably, there are few, if any, long periods of silence in any layer. A Pad layer preferably accompanies certain types of video scenes without another layer playing, as well as allowing a rhythm and/or music layer to fade in on top of it later—with good music as the end result. However, it should be appreciated from the description herein and the drawings, that the above criteria can be deviated from and are not rigid rules.

Step Four: Create Layer Variations (Suggested Techniques and General Guidelines)

After seed audio files are established, compatible layer variations are constructed. For example, the composer can create new music layers and variations of those layers using the original Seed Pad and Rhythm Players as guides and guiding tracks. Reference guides and information on new layers can take the form of text markers placed within a midi sequence (sometimes traditional Chord Symbols can be employed or for example marker points like “End” or “Bridge” can be included). Preferably, new layers have the rhythmic feel as the seed layers.

Once a collection has been assembled with a plurality of layers, the composer can combine various layers to create quick mixes or Quick Mixes that can be subsequently downloaded by users using the computer interface of the present invention, in order to rapidly obtain a composition for subsequent mixing and editing. Such Quick Mixes can be changed and edited by a user, layers replaced, remixed, portions cut and pasted as described above. The Quick Mixes provide users with a rapid means of obtaining desired musical combinations that can be fine tuned to meet immediate needs.

Ideally, each collection has layers with distributed variations in density or activity throughout the Layers. Layer activity is associated with one of three Intensity Levels: (1) High Intensity (Busy or dense Activity), (2) Medium and (3) Low (More Spacious, less busy). A well rounded collection includes, for example, six genres with all layer categories showing all density levels. For example, out of six rhythm layers, two can have a double time feel (High Intensity), two with Medium Intensity (Regular Feel) and two use Low Intensity (e.g., using a half-time feel).

Step Five: Checking Layer Combinations Between Genres

Preferably, the collection composer cross-references the different layers created between genres. Since it is impossible to define all the different DAW formats and capabilities, much less predict the (relentless) advances in Operating Systems on MAC and PC, each layer can be cross-referenced using current DAW systems, such as Digital Performer 4.12. For example, if a MIDI system is used to create the layers in a collection, those MIDI tracks are designated by their type and format for use in the computer interface of the present invention.

Part Two: Exporting the Collection to Audio Formula

Step One: Render Layers to Audio Files

Once the Collection Layers have been cross-referenced, each layer is recorded separately as an audio file. Each layer within a collection is rendered by the composer, preferably (at a minimum) in 16 bit-44K-stereo AIFF format, 24 bit-48k-stereo is more preferable producing audio tracks. The layers are then ready to upload into the computer system of the present invention.

Step One: Upload Layers as Audio Files (i.e. AIFF Files)

By access the Audio Formula FTP site using FTP software and assigned host name and password, the composer or technical professional uploads the audio files (i.e., AIFFS) on to the server of the present invention.

In an alterative embodiment, one or more audio layers can be created using audio “looping”, time compression or extension algorithms, however, these well known techniques are optional. The present invention does not require time compression or extension techniques to change the length of audio compositions.

The present invention, as described above, can be implemented in a variety of differing manners. For example, in one embodiment of the invention, the audio composition service is implemented as a commercial business, with a schedule of fees charged to users for their downloading and use of composers' audio layers. In another embodiment, the software and libraries of audio layer collections can be installed on a local network for private use in house, where royalties are paid to composers based upon usage or flat fee. Alternatively, a single user can purchase software installable on a single computer, with libraries of audio layer collections being added on and/or updated for continuing varieties of audio layer selections.

Each collection of audio layers is created by a single composer or several collaborating composers. For a single collection, each layer is constructed with a common Edit Block so that each layer is synchronous with all other layers in that collection. The composer or other contributor, can then define other the various features of each layer, such as PRIMARY GENRE, SECONDARY GENRE, FUNCTION, INTRUMENT ACTION, etc. Once the definitions are made, the collection can be added to other collections to form a library or update an existing library of collections.

It should be understood that the methods and apparatus of the present invention can be modified in any of a variety of ways to further enhance the audio composition process and user tracking process without departing from the basic features of the present invention.

While several preferred embodiments have been chosen to illustrate the present invention, it will be readily apparent from this disclosure to those skilled in the art that various changes and modifications can be made herein without departing from the scope of the invention as defined in the appended claims. Furthermore, the foregoing description of the embodiments according to the present invention are provided for illustration only, and not for the purpose of limiting the invention as defined by the appended claims and their equivalents.

1. A method for creating an audio composition, comprising:
searching a library of audio sounds to find sounds that meet a desired user criteria;
selecting sounds from those identified in said searching step, that further meet desired user criteria;
mixing the selected sounds selected in said selecting step to achieve a desired audio composition.

2. A method as set forth in claim 1, further comprises the following steps:
downloading preview versions of the selected sounds from the library after said selecting step; and
downloading performance versions of the selected sounds from the library after said mixing step.

3. A system for custom creation of audio compositions comprising:
a computer that includes:
a library of audio sounds;
a computer interface for accessing said library that includes: search window for searching said library and selecting audio sounds; and a mixer for mixing selected audio sounds to create an audio composition.

4. A computer system as set forth in claim 3, wherein said computer system comprises a single computer.

5. A computer system as set forth in claim 3, wherein said computer system comprises:
a server with said library stored therein; and
a remote workstation in electronic communication with said server, said computer interface being operational on said remote workstation.

6. A computer system for custom creation of audio compositions comprising:
a server that includes a library of audio sounds;
a communications link connected to said server;
at least one remote workstation connected to said server through said communications link,
said remote workstation including a computer interface that includes a search window for a user to search the library of audio sounds for desired audio layers;
said computer interface further includes a mixer window for a user to mix selected audio layers downloaded from said library; and
wherein said server includes tracking means for monitoring all activity of remote workstations in communication with said server.

7. A computer system as set forth in claim 6, wherein said library includes a plurality of groups of layers, each group of layers having musical compatibility with one another.

8. A computer system as set forth in claim 7, wherein said layers are stored in said server in two formats, a preview format of lesser audio quality and smaller corresponding file storage size, and a performance format of greater audio quality and larger file storage size.

9. A computer system as set forth in claim 8, wherein said computer interface includes means for downloading preview format versions of selected layers from said server to said remote workstation for mixing using said mixer window.

10. A computer system as set forth in claim 9, wherein said computer interface includes means for downloading performance format versions of selected layers for creation of mixed performance quality audio compositions.

11. A method for creating multi-layer audio compositions from collections of audio sounds, comprising:
composing a plurality of audio sounds having at least one compatible audible feature;
classifying the plurality of audio sounds to form a collection of audio sounds, such that a plurality of such collections forms a library of collections;
searching the library to find audio sounds that meet a desired user criteria;
selecting audio sounds from those identified in said searching step, that meet desired user criteria;

12. A method as set forth in claim 11, further comprises the following steps:
previewing and mixing the selected audio sounds selected in said selecting step to achieve a desired audio composition.
downloading performance versions of the selected audio sounds from the library after said mixing step.

13. Software for installation on a computer, comprising:
means for searching a library of audio sounds to find sounds that meet a desired user criteria;
means for selecting sounds from those identified by said means for searching, that further meet desired user criteria;
mixing the selected sounds selected to achieve a desired audio composition.
